(19) United States
(12) Patent Application Publication
(10) Pub. No.: US 2019/0218026 A1
(43) Pub. Date: Jul. 18, 2019

(54) WASTE COLLECTION DEVICE INTENDED TO RECEIVE A BAG MADE FROM PLASTIC MATERIAL

(71) Applicant: Benjamin MARTIN, CORENC (FR)

(72) Inventor: Benjamin MARTIN, CORENC (FR)

(21) Appl. No.: 16/319,720

(22) PCT Filed: Jul. 20, 2017
(86) PCT No.: PCT/EP2017/068302

§ 371 Date: Jan. 22, 2019

(30) Foreign Application Priority Data
Jul. 21, 2016 (FR) 1656943

(51) Int. Cl. B65F 1/06

(52) U.S. Cl. CPC B65F 1/067; B65F 2220/1063; B65F 2220/102; B65F 2210/1121

(57) ABSTRACT

Disclosed is a waste collection device intended to receive a bag made from plastic material SP. In order to produce a space V1, the blank that constitutes the device includes: a front wall, a back wall, two side walls each including two panels, with hinge lines between same oriented in a vertical direction; at least one flap in the extension of the front wall, with a horizontal hinge line; and at least one opening, provided in the at least one flap.

This invention relates to a design of a collapsible waste collection device, for temporary use, comprising at least one compartment, particularly intended for temporary use such as at festive, cultural, sporting, musical events.

It is known that the problems of waste during major events such as concerts, sporting events pose certain problems of collection of said waste.

In fact, it is necessary to arrange collection points for this waste in a great number of locations because the individuals who attend these venues are taken in by the spectacles, the activities, the concerts and are not inclined to move around to put the waste in a collection container. The collection devices must be of small size to remain manageable, access not always being easy.

Considering the type of event, necessarily temporary, the collection devices are delivered to the location before being distributed to the various use sites.

These collection devices must be delivered by vehicle, hence the space must be small to be able to transport many collection devices in the same vehicle.

A large space for each device is also a disadvantage when the devices must be carried by hand to the various locations.

Hence, there are trash cans that are simple containers, whose shape, with draft angles, allows nesting so as to limit the space requirement.

Another solution consists in envisioning holders having a pole and a hoop integral with said pole, this hoop being designed to receive a trash bag. This bag is generally clamped onto the hoop so that it remains immobilized with the wide-open opening making it possible to receive waste.

This design is unsightly because of inelegant shapes; the container is fragile because its periphery remains unprotected, and the holders are cumbersome and generally heavy to transport either because of the presence of a base or because of the presence of a spike to make it possible to plant the pole in the ground.

Considering the obligations and the necessity of recycling, if possible, the collection of waste must make possible a collection in a selective manner.

The problems faced during the placing of these collection devices are also faced during the removal of these same devices, which means that any increase in weight, within the time of placement, in space, for example, is doubled.

The collection device according to this invention aims to solve the problem posed using a particular embodiment that relies on folding, such as a folding/unfolding method.

In addition, the device according to the invention being folded flat is very compact and the material that forms it results in a very limited weight in and of itself but also because of the elimination of joints and related screws.

Such a collection device therefore makes it possible for an operator easily to transport several devices.

The placing and unfolding are almost instantaneous, just like the folding.

The device is now described in detail according to a particular nonlimiting embodiment, with regard to the accompanying drawings, drawings on which the various figures represent:

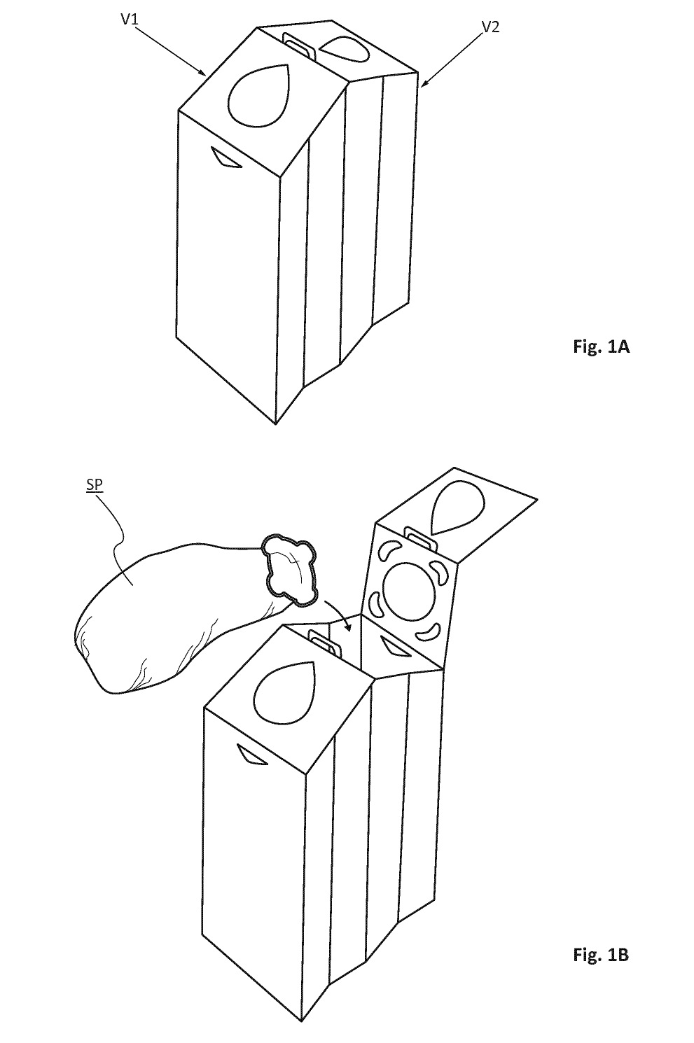

FIGS. 1A and 1B: a perspective view of the double collection device, according to this invention, in open position and in intermediate position intended to show certain corresponding parts,

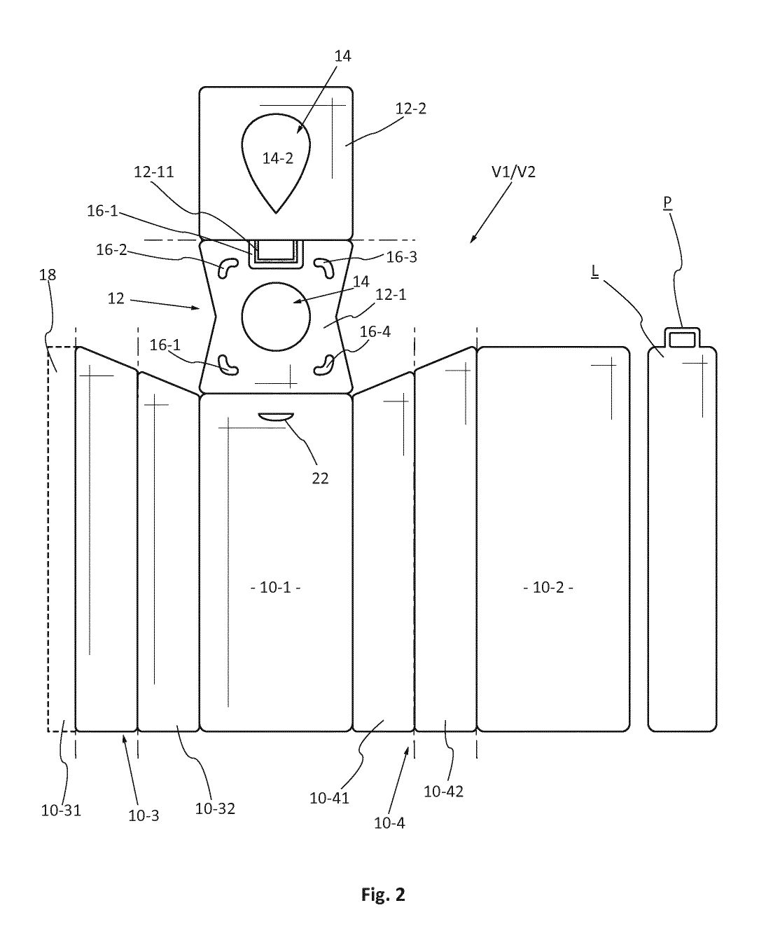

FIG. 2: a view of the panel making possible the embodiment of the device according to this invention,

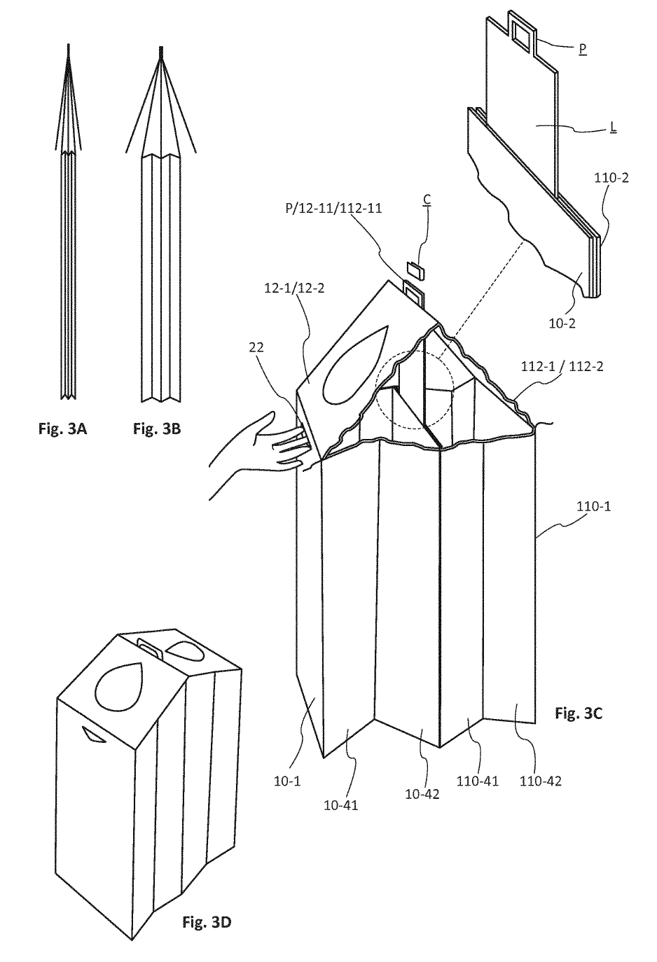

FIGS. 3A to 3D: a block diagram showing the different steps of setting up the device.

The collection device according to this invention, represented in its advanced mode with sorting in FIGS. 1A and 1B, comprises two identical spaces V1 and V2, joined by their rear sides.

This collection device according to this invention is now described in detail according to FIG. 2 in particular, FIG. 1 showing the result.

FIG. 2 represents a panel 10 that is intended to make one of the two spaces V1, V2 according to this invention that comprises a front wall 10-1, a back wall 10-2, two side walls 10-3 and 10-4, each comprising two leaves 10-31, 10-32; 10-41, 10-42.

The fold lines are oriented in a vertical direction, the orientation being considered when the device is in use.

The front wall 10-1 is extended by at least one flap 12, in this case two flaps 12-1, 12-2. These flaps 12 are folded around a horizontal line, here too when the device is in use. These flaps 12 each have at least one opening 14 intended for the passage of waste. The first flap 12-1 is connected with a fold to the front wall 10-1, and the second flap 12-2 is connected with a fold to the first flap 12-1, around a horizontal fold line.

The first flap 12-1 is, in the preferred embodiment, in the shape of a Double conical roll.

On the edge juxtaposed to the second flap 12-2, a handle 12-11 has been cut out and folded relative to said flap, said cut-out creating an opening 16-1.

This first flap 12-1 also has a central opening 14-1 intended for the passage of waste and four other openings 16-2 to 16-5 that complete the first opening 16-1 and are intended to receive parts of trash bags SP made of plastic material, as explained below.

The second flap 12-2 has an approximately square shape, with a central opening 14-2, intended at least to coincide with the central opening 14-1 of the first flap 12-1.

The side walls 10-3, 10-4 are folded together and with each of the front and back walls. The two side walls 10-3, 10-4 are folded inward.

The back wall 10-2 is made with a partial superposition of a connecting flap 18 for the purpose of being able to ensure a connection, for example by gluing, to be able continuously to close the assembly of the back wall, the first side wall, the front wall, and the second side wall when the device is used with a single space. In the case of a double space as in the case described, this flap is useless.

In the preferred embodiment of the invention, the device comprises two spaces V1 and V2, linked back-to-back, i.e., by interposing connecting means between the two back walls of the two spaces, in this case a gluing.

Referenced in the following description are the identical elements of the space V2 like those of the space V1 but increased by 100.

Thus, to make the device with two compartments according to this invention, the implementation consists in using two spaces whose two backs 10-2 and 100-2 are glued in the embodiment presented.

As shown in the magnification of FIG. 3C, a partial gluing is provided leaving open a gap 20.

This invention envisions placing a panel L between the two backs 10-2 and 100-2, said panel also comprising a handle P.

This panel has a width that is less than that of each of the backs and a height at most equal to the height of the backs 10-2, 100-2.

This panel L is interposed between the two backs 10-2 and 100-2 in the open connecting gap 20, forming a sleeve. This panel L can therefore slide, in translation, in the open connecting gap 20. This translation is oriented vertically, i.e., parallel to the two fold lines of the leaves of the side walls.

Thus, the presence of 3 handles, P, 12-11 and 112-11, which can be superposed, are found particularly in FIG. 3C.

Connecting means C in the form of a metal or plastic clip, for example, make it possible to combine together these handles into a threefold handle, the clip C advantageously having a surface part specifically to make possible a user-friendly grip.

Advantageously, the material used is in particular marketed under the registered trademark Hylite®. It is a complex of two sheets of aluminum, of several hundredths of millimeters, placed on both sides of a core of polymer material of several millimeters, such as polypropylene.

Thus, by removing the two sheets of aluminum locally, it is possible to obtain a joint effect, represented in a heavy line in the figures. Polypropylene, of slight thickness, allows many foldings, several thousands, quite sufficient for the application concerned.

As can be found in the various figures, the side walls 10-3, 10-4; 100-3, 100-4 have an angled cut on the upper edges. Once the device is assembled as shown in FIG. 1 or 3, this results in a structure with flaps inclined in the manner of a sloping roof. The inclination also results in the inclination of the openings 14 that are designed to allow waste to pass through. This facilitates the introduction of said waste and limits the accumulation of waste around said device.

Cut-outs forming grip handles 22, 122 are made in the front walls. The block diagram for putting into service the device according to this invention is presented with regard to the FIG. 3.

In FIG. 3A, the device with two spaces V1 and V2 is folded after having been transported or stored in this configuration. The side flaps are folded with the fold line oriented inward, and the front and back walls are flattened against one another, only separated by said side walls. The device comes with a thickness equal to 8 wall thicknesses.

The panel L does not count since it is absorbed by the deformation of the two glued back walls, forming a channel.

In FIG. 3B, the panel L is pulled upward, and the two other handles 12-11 and 112-11, which are made integral with the handle of said panel, are also lifted, pulling the flaps with them.

The user grasps with each hand a grip handle and extends the device to unfold the side walls that unfold, as shown in FIG. 3C.

The unfolding is limited by the dimensions of the flaps that are folded on themselves as shown on FIG. 3D.

These two dual flaps can be lifted up to enable access to the interior of the device, particularly to place a plastic bag intended to accommodate the waste. For this purpose, the connecting means, in this case the clip, are removed to make it possible to remove a handle and to lift up the associated flaps and particularly to lift up the second flap to reach the first flap and to be able to engage a plastic bag there.

It is found that, during assembly, the first flap in Double conical roll form comes precisely perpendicular to the upper edges of the side walls for the purpose of making a jointed closing.

The second flap also has an esthetic function and bears the presentation, just like the front and side walls.

Because of the nature of the materials, the weight is reduced so that an operator can carry several devices and install them in the corresponding area.

The absence of mechanisms and joints in the particularly produced embodiment thus presented makes it possible not to create problems for placing in service, including in the event of bad weather, moisture or mud.

Likewise, maintenance is very reduced, and washing is certainly possible, including with disinfecting products.

This device has large exterior surfaces able to accommodate messages.

1. Waste collection device intended to receive a bag made of plastic material SP, wherein, to make a space V1, the panel that constitutes said device comprises:
a front wall (10-1), a back wall (10-2), two side walls (10-3, 10-4) each comprising two leaves (10-31, 10-32; 10-41, 10-42), with fold lines between them in a vertical orientation,
at least one flap (12-1, 12-2) in the extension of the front wall (10-1), with a horizontal fold line,
at least one opening (14), made in said at least one flap (12-1, 12-2).

2. Waste collection device intended to receive a bag made of plastic material SP, according to claim 1, further comprising a first and second flap (12-1, 12-2) folded together, in a horizontal line.

3. Waste collection device intended to receive a bag made of plastic material SP, according to claim 1, further comprising two spaces V1 and V2, made integral by their rear faces (10-2, 110-2) by connecting means.

4. Waste collection device intended to receive a bag made of plastic material SP, according to claim 3, further comprising a panel L placed in a connecting open gap (20), between the two rear faces (10-2, 110-2), forming a sleeve.

5. Waste collection device intended to receive a bag made of plastic material SP, according to claim 1, wherein the front wall (10-1, 110-1) is extended by at least one flap (12-1, 12-2), each provided with an opening (14).

6. Waste collection device intended to receive a bag made of plastic material SP, according to claim 5, further comprising a first flap (12-1, 112-1) linked by a fold to the front wall (10-1, 110-1) and a second flap (12-2, 112-2) linked by a fold to the first flap (12-1, 112-1).

7. Waste collection device intended to receive a bag made of plastic material SP, according to claim 5, further comprising, on the edge juxtaposed to the second flap (12-2, 112-2), a handle (12-11, 112-11) that comes from a cut-out and that is folded in relation to said flap, said cut-out creating an opening (16-1, 116-1).

8. Waste collection device intended to receive a bag made of plastic material SP, according to claim 5, wherein the first flap (12-1, 112-1) also has other openings (16-2 to 16-5, 116-2 to 116-5) intended to receive parts of trash bags SP.

9. Waste collection device intended to receive a bag made of plastic material SP, according to claim 1, wherein the side walls (10-3, 10-4; 100-3, 100-4) have an angled cut-out on the upper edges.

10. Waste collection device intended to receive a bag made of plastic material SP, according to claim 1, wherein the device is made of a composite material comprising two sheets of metal and a core of polymer material.

11. Waste collection device intended to receive a bag made of plastic material SP, according to claim 2, further comprising two spaces V1 and V2, made integral by their rear faces by connecting means.

12. Waste collection device intended to receive a bag made of plastic material SP, according to claim 2, wherein the front wall is extended by at least one flap, each provided with an opening.

13. Waste collection device intended to receive a bag made of plastic material SP, according to claim 3, wherein the front wall is extended by at least one flap, each provided with an opening.

14. Waste collection device intended to receive a bag made of plastic material SP, according to claim 4, wherein the front wall is extended by at least one flap, each provided with an opening.

15. Waste collection device intended to receive a bag made of plastic material SP, according to claim 6, further comprising, on the edge juxtaposed to the second flap, a handle that comes from a cut-out and that is folded in relation to said flap, said cut-out creating an opening.

16. Waste collection device intended to receive a bag made of plastic material SP, according to claim 6, the first flap also has other openings intended to receive parts of trash bags SP.

17. Waste collection device intended to receive a bag made of plastic material SP, according to claim 7, the first flap also has other openings intended to receive parts of trash bags SP.

18. Waste collection device intended to receive a bag made of plastic material SP, according to claim 2, wherein the side walls have an angled cut-out on the upper edges.

19. Waste collection device intended to receive a bag made of plastic material SP, according to claim 3, wherein the side walls have an angled cut-out on the upper edges.

20. Waste collection device intended to receive a bag made of plastic material SP, according to claim 4, wherein the side walls have an angled cut-out on the upper edges.
